(19) United States
(12) Patent Application Publication
(10) Pub. No.: US 2026/0196547 A1
(43) Pub. Date: Jul. 9, 2026

(54) REDOX FLOW BATTERY, WITH AT LEAST ONE CELL

(71) Applicant: VANEVO GMBH, Oldenburg (DE)

(72) Inventor: Jan GROSSE AUSTING, Oldenburg (DE)

(21) Appl. No.: 19/132,758

(22) PCT Filed: Nov. 22, 2023
(86) PCT No.: PCT/EP2023/082689

§ 371 Date: May 23, 2025

(30) Foreign Application Priority Data
Nov. 28, 2022 (DE) 102022131417.0

(51) Int. Cl. H01M 8/18; H01M 8/04276

(52) U.S. Cl. CPC H01M 8/188; H01M 8/04276

(57) ABSTRACT

A redox-flow battery includes a cell having two half-cells, each half-cell having a half-cell interior for receiving an electrolyte, an electrode and a membrane being associated with each cell and the half-cells being arranged in a stack, electrolyte supply means and/or electrolyte discharge means being assigned to each half-cell, and the electrolyte supply means being connected to an electrolyte reservoir via a supply line and the electrolyte discharge means being connected to an electrolyte reservoir via a discharge line. The supply line is subdivided into supply sub-lines; the discharge line is subdivided into discharge sub-lines; the supply sub-line and/or the discharge sub-line is/are assigned to two or more half-cells; and the supply sub-lines and the discharge sub-lines are arranged outside the stacking surfaces of the half-cells.

### BACKGROUND OF THE INVENTION

### Field of the Invention

The invention relates to a redox flow battery, with at least one cell, wherein a cell is made up of two half cells, wherein each half cell includes at least one half-cell interior for receiving an electrolyte, wherein at least one electrode and at least one membrane are associated with each cell and wherein the half cells are arranged in a stack, wherein at least one electrolyte inlet and/or at least one electrolyte outlet is respectively associated with the half cells and wherein the electrolyte inlets are connected to an electrolyte tank via a supply line and the electrolyte outlets are connected to an electrolyte tank via a discharge line.

Brief Description of the Related Art Redox flow batteries are employed in particular in stationary applications and are advantageous due to their long cycle life, non-combustibility and independent scalability of power and capacity. In redox flow batteries, the energy is stored in liquid electrolytes. For the storage and discharge processes, i.e. the charging and discharging the battery, the electrolytes circulate through cell stacks in which the conversion between electrical and chemical energy takes place. The cell stacks, also referred to as stacks, generally consist of a large number of individual cells connected electrically in series. A redox flow stack typically consists of 35 to 40 cells, wherein each cell consists of components such as cell frames, electrodes, membranes and sealing elements arranged therebetween. These elements are, for example, stacked on top of each other and sealed, wherein sealing can occur by means of sealing elements or by sealing the elements from the outside.

Known cell frames often have bored holes through which electrolyte supply and discharge lines are formed. The respective electrolyte flows through these lines in and out of the half cells of the corresponding polarity. The function of the lines is thus to transport the electrolyte into and out of the stack.

It is also possible, however, to form the supply and discharge lines outside the cell frame. For example, DE 10 2011 122 010 A1 describes a redox flow battery that comprises at least one cell frame defining a cell interior and at least one supply line positioned outside the cell frame for supplying electrolyte to the cell interior and/or at least one disposal line positioned outside the cell frame for removing electrolyte from the cell interior. The supply line for supplying electrolyte to the cell interior and/or the disposal line for removing electrolyte from the cell interior is in fluid contact with the cell interior via a plurality of separate flow channels in the cell frame.

Shunt currents between half cells of the same polarity are one cause that reduces efficiency and, due to corrosion processes, service life. The individual cells of a stack are generally electrically connected in series, while the electrolyte supply is generally in parallel for half cells of the same polarity. Half cells of the same polarity, but with respectively different potentials, are electrically conductively connected to each other by the electrically conductive electrolyte. This makes it possible for shunt currents to flow between the half cells.

The number of half cells that are electrically connected in series and supplied with electrolyte in parallel has a substantial influence on the magnitude of the shunt currents. The more cells that are electrically connected in series and that have an electrolyte supply/removal in parallel via an electrolyte line, the more disproportionately the shunt currents increase. In order to limit the number of half cells and thereby the shunt currents, stacks with a maximum of 35-40 cells are thus often found in the prior art.

### SUMMARY OF THE INVENTION

The underlying object of the invention is to propose a redox flow battery of the type described in the foregoing in which shunt currents are reduced in a simple manner without limiting the number of cells in a stack and without seriously increasing hydraulic losses in the electrolyte conduction system.

This object is achieved by a redox flow battery with the features of the independent claim(s). Further developments and advantageous embodiments are indicated in the dependent claim(s).

In a redox flow battery, with at least one cell, wherein a cell is made up of two half cells, wherein each half cell includes at least one half-cell interior for receiving an electrolyte, wherein at least one electrode and at least one membrane are associated with each cell and wherein the half cells are arranged in a stack, wherein at least one electrolyte inlet and/or at least one electrolyte outlet is respectively associated with the half cells, and wherein the electrolyte inlets are connected to an electrolyte tank via at least one supply line and the electrolyte outlets are connected to an electrolyte tank via at least one discharge line, it is provided according to the essential features of the invention that the at least one supply line is divided into supply sub-lines, the at least one discharge line is divided into discharge sub-lines, the at least one supply sub-line and/or the at least one discharge sub-line is associated with at least two half cells, and the supply sub-lines and the discharge sub-lines are arranged outside the stack surfaces of the half cells. Redox flow batteries include at least one cell, preferably a plurality of cells, wherein at least one cell is made up of two half cells. Each half cell includes at least one half-cell interior into which an electrolyte is introduced via an electrolyte inlet and out of which an electrolyte is discharged via an electrolyte outlet. The half-cell interiors are respectively closed off at least in sections by at least one electrode and at least one membrane. A porous, electrically conductive felt can be arranged in a half-cell interior so that the surface area for the electrochemical reaction in the half-cell interior is increased. The electrodes and the membranes are essentially flat and include stack surfaces as well as side surfaces that run around the sides and delimit the stack surfaces. Supply lines and discharge lines for supplying the half-cell interiors with electrolyte from an electrolyte tank are provided outside the stack surfaces respectively planes. To reduce the shunt currents, the number of half cells that are supplied with electrolyte in parallel can be limited by using electrolyte sub-lines, i.e. supply sub-lines and discharge sub-lines. The supply sub-lines respectively supply a number of half cells with electrolyte, and the electrolyte is discharged from a number of half cells through the discharge sub-lines. This produces substacks which remain electrically connected in series, but which have separate electrolyte conduction systems. With external electrolyte lines, it is easy to realize a stack division with respect to the electrolyte sub-lines into substacks. This does not increase the technical complexity within the stack area of the half cells. The electrolyte sub-lines can be designed in such a manner that the number of half cells connected in parallel to a supply sub-line and/or a discharge sub-line can be limited to any number of half cells. Preferably, less than the total number of half cells in the stack are respectively supplied with electrolytes by a supply sub-line and/or a discharge sub-line. Limiting the number of half cells that are supplied by a common electrolyte sub-line can reduce the shunt currents. This solution is associated with comparatively low hydraulic pressure losses, which has a positive effect on the efficiency of the overall system.

In one embodiment of the invention, the supply sub-lines and/or the discharge sub-lines are arranged to reduce shunt currents. The arrangement of electrolyte sub-lines, i.e. the use of the supply sub-lines and/or the discharge sub-lines, reduces the number of half cells supplied in parallel with electrolyte, whereby the shunt currents can also be reduced. The magnitude of the shunt currents is decisively influenced by the number of half cells that are supplied in parallel by an electrolyte sub-line and by the electrical conductivity of the electrolyte within an electrolyte sub-line. The latter can be influenced by the choice of diameter and the length of the electrolyte sub-line.

In one embodiment of the invention, the at least two supply sub-lines and/or at least two discharge sub-lines are connected in parallel to the electrolyte tank. To reduce the probability of shunt currents occurring, preferably all supply sub-lines and/or discharge sub-lines are connected to the electrolyte tank in parallel. The use of electrolyte sub-lines that supply the half cells in parallel reduces the number of cells connected in series, so that the occurrence of shunt currents can be reduced.

In one embodiment of the invention, the electrolyte sub-lines are only connected to a fraction of the total number of half cells in order to reduce shunt currents. An electrolyte sub-line, i.e. a supply sub-line or a discharge sub-line, is connected to a fraction of the total number of half cells in the stack of the redox flow battery. A fraction of the total number can be at least two half cells, while the maximum number of half cells connected by an electrolyte sub-line is lower than the total number of half cells. Reducing the number of half cells connected by an electrolyte sub-line reduces the occurrence of shunt currents.

In one embodiment of the invention, a supply sub-line and/or a discharge sub-line is respectively associated with a half-cell group. A half-cell group is a number of preferably adjacent half cells in the overall stack. The half-cell group is supplied with electrolyte by a supply sub-line and the electrolyte is discharged through an electrolyte discharge line. This can reduce the occurrence of shunt currents. A further advantage of grouping half cells is that less engineering effort is required to implement the electrolyte sub-lines compared to electrolyte sub-lines that respectively only connect one half cell to the electrolyte line. A further resulting advantage is the reduction of pressure losses. In addition, fewer sealing points are required to prevent electrolyte leakage than when each individual half cell is connected to an electrolyte sub-line. By grouping half cells, a reduction of shunt currents can be achieved together with optimized hydraulic pressure ratios and a reduced engineering effort.

In a further development of the invention, at least one supply sub-line and/or at least one discharge sub-line respectively includes at least one electrolyte-path-extending element. A further reduction of shunt currents can be achieved by extending the electrolyte path between two half cells, as the extended electrolyte path increases the electrical resistance between the half cells. The occurrence of shunt currents can also be reduced by increasing the electrical resistance between two electrolyte sub-lines, i.e. between two discharge sub-lines or two supply sub-lines, by extending the electrolyte path between the sub-lines. For this purpose, the electrolyte sub-lines can respectively include elements that extend the electrolyte path. The electrolyte-path-extending elements can be formed, for example, by plate-like elements, hose lines, pipe lines, or the like.

In a further development of the invention, the electrolyte-path-extending elements are intermediate elements. The intermediate elements are arranged within the supply sub-line and/or discharge sub-line, and the intermediate elements are designed so as to extend the electrolyte path between at least two half cells. The sub-lines, i.e. the discharge sub-lines through which the electrolyte is conducted from a number of half cells to an electrolyte tank and the supply sub-lines through which a number of half cells are respectively supplied with electrolyte, can include intermediate elements. In particular, the intermediate elements can be arranged within a sub-line, i.e. within a discharge sub-line and/or within a supply sub-line. The intermediate elements increase the electrical resistance between at least two half cells or a group of half cells along the electrolyte path by extending the electrolyte path. For example, an intermediate element can be associated with each electrolyte inlet and each electrolyte outlet of each half cell. The intermediate elements can be, for example, flat plates which increase the electrolyte path between the half cells. It is also possible for the intermediate elements to respectively include channel-like structures or the like, through which the electrolyte flows on the path to the electrolyte tank. The additional path length produces an increase in the electrical resistance between two half cells, so that the occurrence of shunt currents between the half cells is reduced. After running through the extended electrolyte paths of the intermediate elements, the electrolyte transported from the half cells can be collected in an ante-volume before it is fed, for example via a hose line, to the electrolyte tank. The arrangement of electrolyte-path-extending intermediate elements brings about an increase in electrical resistance and consequently a reduction of shunt currents between two half cells.

In a further development of the invention, one of the intermediate elements is associated with each half cell and/or each half-cell group. Each electrolyte inlet and each electrolyte outlet of each half cell can be associated with a corresponding intermediate element. The half cells can also be combined into groups, so that an intermediate element is associated with a plurality of half cells.

In a further embodiment of the invention, the intermediate elements have a plate-like design. The plate-like intermediate elements can be respectively associated with a half cell of the redox flow battery and can be arranged essentially parallel to the planes spanned by the stack surfaces of the stack, for example the planes spanned by the membranes, electrodes or frame elements. The plate-like intermediate elements extend the electrolyte path between two half cells or between groups of half cells.

In one embodiment of the invention, the plate-like intermediate elements respectively include at least one fluid-guiding structure. The fluid-guiding structures have a channel-like design and extend in a meandering and/or labyrinthine manner in the plane spanned by the plate-like intermediate element. A plate-like intermediate element is associated with each half cell, wherein the plate-like intermediate elements are arranged in the plane spanned by the respective stack surfaces of the half cells. The intermediate elements include channel-like structures through which the electrolyte can be conducted. The meandering and/or labyrinthine course of the channel-like structures brings about an extension of the electrolyte path between the half cells, in particular between two adjacent half cells or two adjacent half-cell groups. This likewise increases the electrical resistance between the half cells, thus reducing the magnitude of shunt currents between the half cells. For example, the intermediate elements can be made of a plastic or the like and the channel-like structures can be made, for example, by milling, in a 3D printing process, by shaping in an injection-moulding process or the like.

In one embodiment of the invention, the at least one discharge sub-line and/or the at least one supply sub-line respectively include an ante-volume for collecting the fluid discharged by the intermediate elements or to be received by the intermediate elements. An ante-volume can be respectively associated with a number of half cells, in particular the half cells of a supply sub-line or a discharge sub-line. For example, the electrolyte that is discharged from the intermediate elements of the half cells of a discharge sub-line can be collected in the ante-volume and fed collectively to an electrolyte tank. The same applies to the supply sub-lines, which respectively include an ante-volume from which the electrolyte flows into the intermediate elements of the supply sub-line.

In one embodiment of the invention, at least one electrolyte-path-extending element is designed so as to extend the electrolyte path between at least two supply sub-lines and/or between at least two discharge sub-lines. Electrolyte-path-extending elements are provided to increase the electrical resistance between two electrolyte sub-lines, i.e. between two supply sub-lines or between two discharge sub-lines. These elements can be designed, for example, as hose lines, pipe lines, or the like, which connect to the supply sub-lines and/or discharge sub-lines. For example, the electrolyte from the half cells associated with a discharge sub-line can flow from the half cells into the discharge sub-lines. From the discharge sub-line, the electrolyte passes into the electrolyte-path-extending element, for example a hose line, which, for example, runs into a collection chamber in which the discharged electrolyte of all discharge sub-lines of a stack is collected. The collection chamber includes an electrolyte-conducting connection to the electrolyte tank. Alternatively, the electrolyte-path-extending elements of all sub-lines can be connected directly to an electrolyte-conducting line, wherein the connection to the electrolyte tank is established via the electrolyte-conducting line. The electrolyte-path-extending elements of the electrolyte sub-lines increase an electrical resistance between at least two electrolyte sub-lines and thereby reduce the occurrence of shunt currents across two electrolyte sub-lines.

In one embodiment of the invention, at least one electrolyte-path-extending element is formed by at least one hose line or at least one channel or at least one pipe line. The electrolyte-path-extending elements can be, for example, hose lines, pipe lines, channels or the like, which are arranged between the electrolyte sub-lines and the electrolyte tank. The electrolyte-path-extending elements can run into a collection chamber in which the discharged electrolyte or the electrolyte to be received of all electrolyte sub-lines of a stack is collected. The extension elements reduce the magnitude of the shunt current between the electrolyte sub-lines.

In one embodiment of the invention, at least two electrolyte sub-lines are connected to one another by an interruption device, and the interruption device is designed to at least reduce the cross section of the electrolyte path between the at least two electrolyte sub-lines. An interruption device can be, for example, a rotatable disc, an impeller or the like, which at least reduces the cross section of the direct electrolyte path between two electrolyte sub-lines, for example between two adjacent electrolyte sub-lines. In particular, the electrolyte path can also be completely interrupted. For example, only one sub-line opening of two electrolyte sub-lines can be opened in the direction of the electrolyte line by the interruption device at any one time, while the other sub-line openings are closed by the interruption device. There is thus no permanent contact or only an electrolyte path with a greatly reduced cross section between the two sub-lines, so that the occurrence of shunt currents between the two sub-lines is reduced.

In one embodiment of the invention, the interruption device is designed to also temporarily reduce the cross section of the electrolyte path between the respective electrolyte line and all but one electrolyte sub-line, and the interruption device is designed to periodically change the electrolyte sub-line with an unreduced cross section to the electrolyte line.

For example, it is possible for only one sub-line opening of two or more electrolyte sub-lines to be opened by the interruption device at any one time, while the other sub-line opening or sub-line openings are closed by the interruption device. The electrolyte path between at least one supply sub-line and the corresponding electrolyte supply line can be at least temporarily interrupted or at least reduced. The same applies to the electrolyte path between at least one discharge sub-line and the corresponding electrolyte discharge line.

In one embodiment of the invention, the interruption device is an impeller. An impeller or alternatively a paddle wheel hardly increases the hydraulic resistance in the electrolyte path but reduces the cross section of the electrolyte path between the electrolyte sub-lines considerably. In particular, the impeller can have a design similar to an impeller flow meter. The impeller can include blades that can be connected to one another in an axis of rotation. The impeller can be arranged in a housing so as to be rotatable about the axis of rotation. The housing can include connections for the electrolyte sub-lines and the corresponding electrolyte line. The electrolyte flows around the impeller, thereby driving it. The blades reduce the cross section between the lines. The electrolyte flow is hardly affected by the rotatable mounting of the impeller, however, so that the pressure losses that occur are low. The electrolyte sub-lines and the electrolyte line that leads to the tank can be connected at various positions around the impeller. The cross section of the electrolyte path between the different electrolyte sub-lines or between the electrolyte sub-lines and the electrolyte line is significantly reduced by the impeller blades around which the electrolyte flows without significantly increasing the hydraulic resistance. Reducing the cross section reduces the occurrence of shunt currents between the sub-lines separated by the impeller.

In an alternative embodiment, the interruption device is at least one rotatable closure that includes an opening. The rotatable closure is designed to be movable at least between a position that opens a first electrolyte sub-line and a position that opens a second electrolyte sub-line. For example, electrolyte sub-lines can respectively include an opening through which the electrolyte can flow towards the electrolyte tank via a fluid line. These openings can be arranged, for example, in a plane perpendicular to the stack surface of the cells. The direct electrolyte path between the two electrolyte sub-lines can be interrupted by a rotatable closure that is designed in such a manner that only one opening of two adjacent electrolyte sub-lines is open at any one time. The rotatable closure can be, for example, disc-shaped with an opening or alternatively half-disc-shaped, i.e. semi-circular, and is arranged so as to be rotatable about an axis that is parallel to the stack surface of the half cells. In particular, the rotatable closure can be moved between the two opening positions by an electrical control system or the like.

### BRIEF DESCRIPTION OF THE DRAWINGS

The invention is explained in more detail in the following with reference to an example embodiment illustrated in the figures. In detail, the schematic illustrations show:

FIG. 1: a half-cell frame for external electrolyte lines;

FIG. 2: a cell stack of a redox flow battery with external electrolyte lines;

FIG. 3: discharge sub-lines of a cell stack with connections to an electrolyte tank;

FIG. 4: discharge sub-lines of a cell stack with intermediate elements;

FIG. 5: discharge sub-lines with electrolyte-path-extending elements;

FIG. 6: discharge sub-lines with an interruption device and

FIG. 7: an interruption device designed as an impeller

### DETAILED DESCRIPTION OF THE PREFERRED EMBODIMENTS

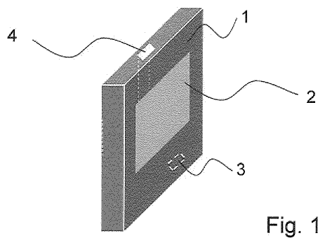

FIG. 1 shows a frame element 1 for a half cell that includes a half-cell interior 2 for receiving an electrolyte and both an electrolyte inlet 3 and an electrolyte outlet 4 through which the electrolyte can flow into and then out of the half-cell interior 2. The electrolyte inlet 3 and the electrolyte outlet 4 are designed in such a manner that the electrolyte can be conducted outside the stack surface of the frame element 1.

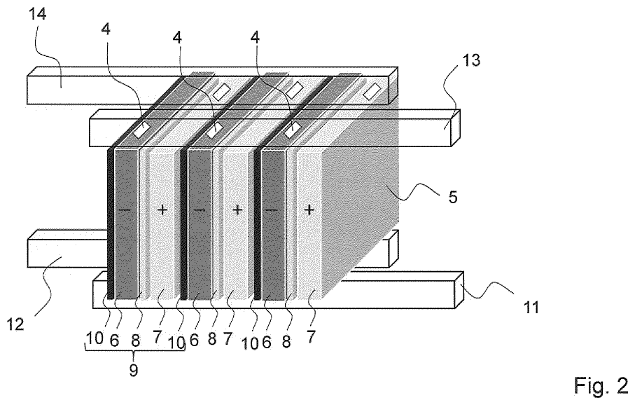

A stack 5 of a redox flow battery is illustrated schematically in FIG. 2. The half cells 6, 7 alternately have different polarities. Two half cells 6, 7 with different polarities are separated from each other by a membrane 8. A cell 9 is made up of two half cells 6, 7, and electrodes 10 are associated with each cell 9. Supply lines 11, 12 for supplying electrolyte to the half cells 6, 7 and discharge lines 13, 14 for discharging the electrolyte from the half cells 6, 7 are arranged outside the stack surface or plane of the electrodes 10, the membranes 8 and the surfaces or planes spanned by the half cells 6, 7. The supply line 11 is associated with the half cells 6 with a negative polarity, and the supply line 12 is associated with the half cells 7 with a positive polarity. The discharge line 13 is associated with the half cells 6 with a negative polarity, and the discharge line 14 is associated with the half cells 7 with a positive polarity.

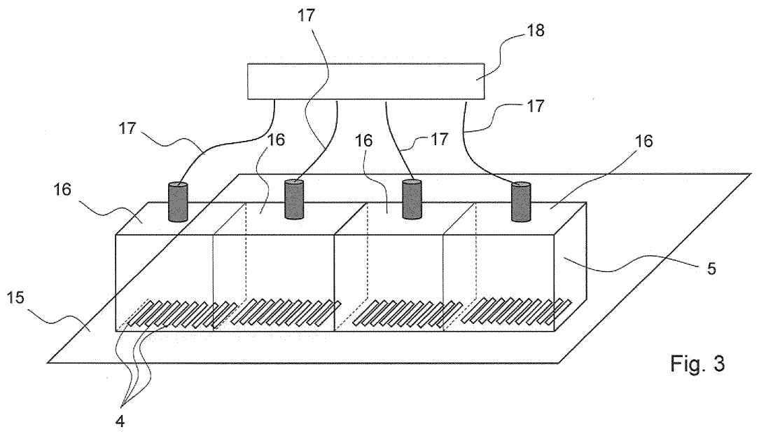

FIG. 3 schematically shows a top side 15 of a stack 5. A discharge line 13 is divided into discharge sub-lines 16. A number of electrolyte outlets 4 are associated with one discharge sub-line 16. The electrolyte that flows out of the half cells 6 is collected in the volume of the discharge sub-line 16 and fed to an electrolyte tank 18 via an electrolyte-conducting connection 17, for example a hose line or a pipe line. The number of half cells 6 that are supplied with electrolyte in parallel is reduced by the sub-lines, which leads to a reduction in occurring shunt currents. The stack 5 is thus divided into substacks that remain electrically connected in series but have separate electrolyte conduction systems.

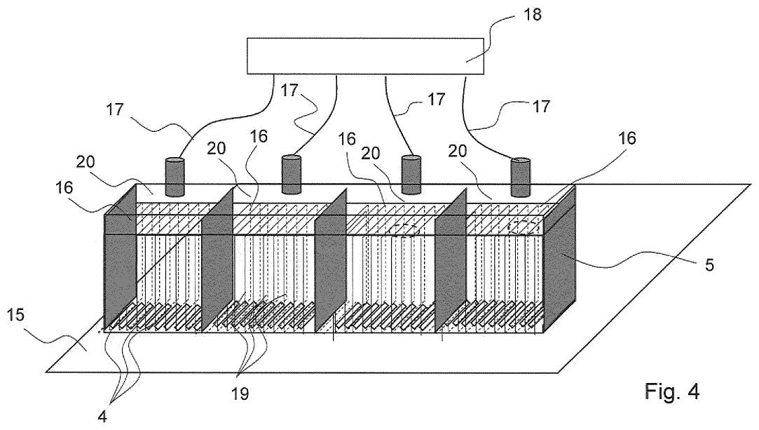

FIG. 4 shows a top side 15 of a stack 5 with discharge sub-lines 16. Electrolyte-path-extending elements in the form of plate-like intermediate elements 19 are arranged in the discharge sub-lines 16. An intermediate element 19 can be associated with each half cell 6, 7 of a discharge sub-line 16. It is also possible, however, for an intermediate element 19 to be associated with a group of half cells 6. The intermediate elements 19 increase the electrical resistance between at least two half cells 6 along the electrolyte path by extending the electrolyte path. For this purpose, the intermediate elements 19 can include, for example, channel-like structures or the like through which the electrolyte can flow. The discharge sub-lines 16 can respectively include an ante-volume 20 in which the electrolyte is collected after leaving the intermediate elements 19 before the electrolyte is fed to the electrolyte tank 18 via electrolyte-conducting lines 17.

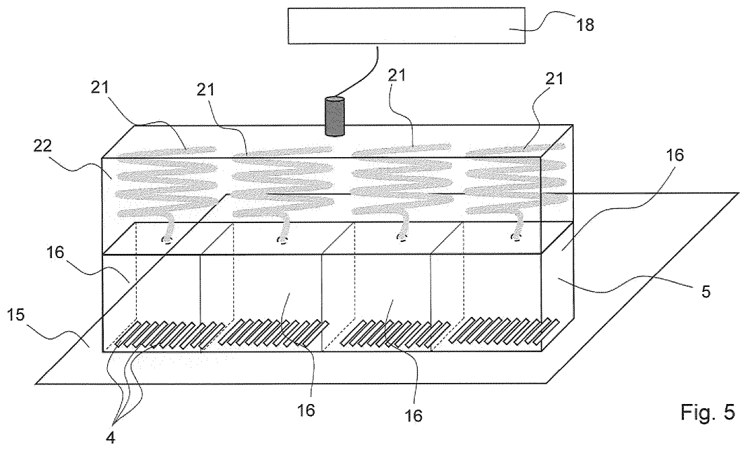

FIG. 5 schematically shows a top side 15 of a stack 5 with discharge sub-lines 16. To increase the electrical resistance between two discharge sub-lines 16, electrolyte-path-extending elements 21 are arranged at the discharge sub-lines 16. The electrolyte-path-extending elements 21 can be implemented, for example, by channels, hose lines, pipe lines or the like. The electrolyte flowing out of the half cells 6 associated with a discharge sub-line 16 can flow into the electrolyte-path-extending element 21. The electrolyte-path-extending elements 21 run into a collection chamber 22, which can be flooded by the electrolyte being discharged. As the electrolyte-path-extending elements 21 are connected to the discharge sub-lines 16, the extension of the electrolyte path increases the electrical resistance between the discharge sub-lines 16. The electrolyte can be fed from the collection chamber 22 to an electrolyte tank 18 via an electrolyte-conducting line 17.

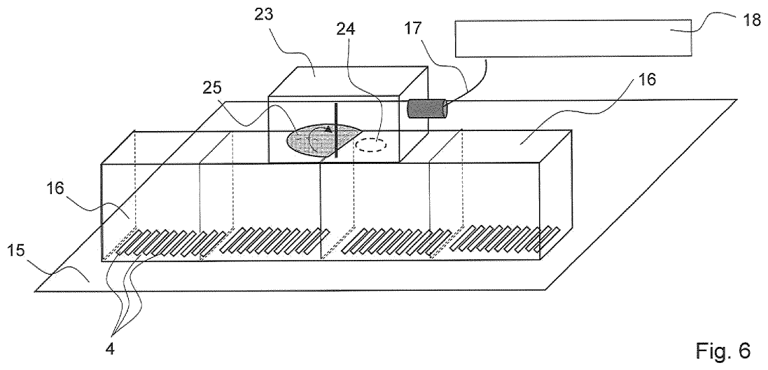

FIG. 6 shows two discharge sub-lines 16, which are connected to each other by an interruption device 23. The discharge sub-lines 16 respectively include an opening 24 through which the electrolyte can pass into the interruption device 23. The interruption device 23 is a rotatable closure in the form of a truncated rotatable disc 25. The rotatable disc 25 is arranged in such a manner that only one opening 24 of the discharge sub-lines 26 is open at any one time. The interruption device 23 interrupts the direct electrolyte path between the electrolyte sub-lines 16, so that the occurrence of shunt currents between the adjacent electrolyte sub-lines 16 is reduced. The electrolyte is fed from the interruption device 23 in which the electrolyte of the two adjacent discharge sub-lines 16 is collected to an electrolyte tank 18.

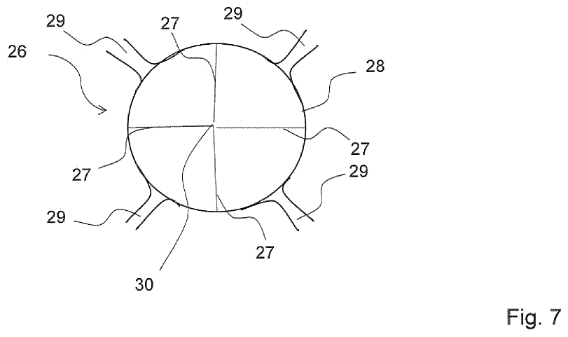

FIG. 7 shows an interruption device 23 in the form of an impeller 26. The impeller 26 with its blades 27 is arranged in a housing 28. The blades 27 are connected to one another in an axis of rotation 30. The impeller 26 is arranged in the housing 28 so as to be rotatable about the axis of rotation 30. The housing 28 includes connections 29 for the electrolyte sub-lines 16 and the corresponding discharge line or supply line. The electrolyte flows around the impeller 26, thereby driving it. The blades 27 reduce the cross section between the lines and the sub-lines as well as between the respective sub-lines.

### LIST OF REFERENCE NUMBERS

1 Frame element
2 Half-cell interior
3 Electrolyte inlet
4 Electrolyte outlet
5 Stack
6 Negative half-cell
7 Positive half-cell
8 Membrane
9 Cell
10 Electrode
11 Supply line for negative half cells
12 Supply line for positive half cells
13 Discharge line for negative half cells
14 Discharge line for positive half cells
15 Side of stack
16 Discharge sub-line
17 Electrolyte-conducting line
18 Electrolyte tank
19 Intermediate element
20 Ante-volume
21 Electrolyte-path-extending elements
22 Collection chamber
23 Interruption device
24 Opening between electrolyte sub-line and electrolyte line
25 Disc
26 Impeller
27 Blades
28 Housing
29 Connections
30 Axis of rotation

1. Redox flow battery, with at least one cell, wherein a cell is made up of two half cells, wherein each half-cell includes at least one half-cell interior for receiving an electrolyte, wherein at least one electrode and at least one membrane are associated with each cell and wherein the half cells are arranged in a stack, wherein at least one electrolyte inlet and/or at least one electrolyte outlet is respectively associated with the half cells and wherein the electrolyte inlets are connected to an electrolyte tank via at least one supply line and the electrolyte outlets are connected to an electrolyte tank via at least one discharge line,
the at least one supply line is divided into supply sub-lines,
the at least one discharge line is divided into discharge sub-lines,
the at least one supply sub-line and/or the at least one discharge sub-line associated with at least two half cells, and
the supply sub-lines and the discharge sub-lines are arranged outside the stack surfaces of the half cells.

2. The redox flow battery according to claim 1, wherein the supply sub-line and/or the discharge sub-line are arranged to reduce shunt currents.

3. The redox flow battery according to claim 1, wherein the at least two supply sub-lines and/or at least two discharge sub-lines are connected in parallel to the electrolyte tank.

4. The redox flow battery according to claim 1, wherein the electrolyte sub-lines are connected to only a fraction of the total number of half cells in order to reduce shunt currents.

5. The redox flow battery according to claim 1, wherein a supply sub-line and/or a discharge sub-line is respectively associated with a half-cell group.

6. The redox flow battery according to claim 1 wherein at least one supply sub-line and/or at least one discharge sub-line respectively includes at least one electrolyte-path-extending-element.

7. The redox flow battery according to claim 6, wherein the electrolyte-path-extending elements are intermediate elements, wherein the intermediate elements are arranged within the supply sub-line and/or discharge sub-line and wherein the intermediate elements are designed so as to extend the electrolyte path between at least two half cells.

8. The redox flow battery according to claim 7, wherein one of the intermediate elements is associated with each half cell and/or each half-cell group.

9. The redox flow battery according to claim 7, wherein the intermediate elements have a plate-like design.

10. The redox flow battery according to claim 9, wherein the plate-like intermediate elements respectively include at least one fluid-guiding structure, wherein the fluid-guiding structures have a channel-like design and extend in a meandering and/or labyrinthine manner in the plane spanned by the plate-like intermediate element.

11. The redox flow battery according to claim 7, wherein the at least one supply sub-line and/or the at least one discharge sub-line respectively includes an ante-volume for collecting the electrolyte discharged by the intermediate elements or to be received by the intermediate elements.

12. The redox flow battery according to claim 1, wherein at least one electrolyte-path-extending element is designed so as to extend the electrolyte path between at least two supply sub-lines and/or between at least two discharge sub-lines.

13. The redox flow battery according to claim 12, wherein at least one electrolyte-path-extending element is formed by at least one hose line or at least one channel or at least one pipe line.

14. The redox flow battery according to claim 1, wherein at least two electrolyte sub-lines are connected to one another by an interruption device, and the interruption device is designed to at least reduce the cross section of the electrolyte path between the at least two electrolyte sub-lines.

15. The redox flow battery according to claim 14, wherein the interruption device is designed to also temporarily reduce the cross section of the electrolyte path between the respective electrolyte line and all but one electrolyte sub-line, and the interruption device is designed to periodically change the electrolyte sub-line with an unreduced cross section to the electrolyte line.

16. The redox flow battery according to claim 14 wherein the interruption device is an impeller.

17. The redox flow battery according to claim 14, wherein the interruption device is a rotatable closure that includes at least one opening, and the rotatable closure is designed to be movable between a position that opens a first electrolyte sub-line and a position that opens a second electrolyte sub-line.
